(19) United States
(12) Patent Application Publication
(10) Pub. No.: US 2004/0200628 A1
(43) Pub. Date: Oct. 14, 2004

(54) Control for a hand-held electric machine tool

(76) Inventors: Harald Schmitzer, Werdenberg (CH); Hans Boeni, Buchs/SG (CH); Carlos Oliveira, Feldkirch (AT); Roland Schaer, Grabs (CH); Christoph Wuersch, Werdenberg (CH)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/820,331

(22) Filed: Apr. 8, 2004

(30) Foreign Application Priority Data
Apr. 11, 2003 (DE) 103 16 844.3

(51) Int. Cl. B25D 1/00

(52) U.S. Cl. 173/1; 173/2

(57) ABSTRACT

A hand-held electric machine tool (1) with an at least partly rotary-driven tool receptacle (2) for a tool and a press switch (5) arranged at a handle (4) on the workpiece side for activating the connection of a power source (6) to an electric motor (7) connected to control electronics (10) which are connected to a force sensor (8), wherein the force sensor (8) is arranged between the tool receptacle (2) and the handle (4) and is designed for measuring a pressing force (F) of the hand-held electric machine tool pressing against a workpiece. In addition, an intuitive control process for the hand-held electric machine tool (1) is claimed.

### BACKGROUND OF THE INVENTION

The invention describes a control for an at least partly rotary hand-held electric machine tool such as a combination hammer drill.

Hand-held electric machine tools usually have a regulator switch on the workpiece side of a handle. This regulator switch is usually controlled by the index finger of the user's hand which grasps and guides the handle. When actuated, the regulator switch closes the electric circuit through the electric motor to the main power supply on the one hand and controls electronic regulation of the electric motor depending upon press-in depth on the other hand.

The movement of the index finger when actuating the press switch arranged on the workpiece side of the handle for activating the connection of the electric motor to the power source is intuitively correlated with the grip reflex around the handle which is necessary for the user to safely guide a hand-held electric rotary machine tool with the hand; accordingly, it establishes the user's readiness to activate the electric motor. However, for sensitive work the user must manually control the pressing force for pressing the hand-held electric machine tool against the substrate and the position of the finger on the regulator switch. On the one hand, motor skill is required and, on the other hand, a certain degree of concentration which is not necessarily always exercised is required, particularly during monotonous activities in commercial construction.

According to DE19534850, a hand-held electric rotary machine tool has a regulator switch which closes the electric circuit through the electric motor to the power supply when actuated and also activates regulating electronics in the electric motor which regulate the rotational speed of the electric motor to a maximum reaction torque depending on a force that is measured at an internal sensor. In US2001/0025421 and DE19738092, the reference rotational speed of the regulation of the electric motor is deliberately changed after activation, depending on a force measured at a force sensor accessed by the thumb, by the regulator switch that is actuated with the index finger. Control commands which are given intuitively through the handling of the hand-held electric machine tool itself are not taken into account by regulation of this kind.

According to DE4401664, a rotating and hammering hand-held electric machine tool has a regulation of the electric motor which varies according to the desired operating mode. According to WO0219048, a rotating and hammering hand-held electric machine tool has an optimal regulation of the operating state with respect to rotational speed, impact frequency and pressing force depending on the selected operating mode in that many sensor-detected parameters, including the forces acting upon the hand-held electric machine tool, are evaluated in an adaptive process analysis. This optimization is carried out exclusively by maximizing the forward feed of the drill.

According to DE 10034359, a hammering hand-held electric machine tool has a pressing force sensor for controlling the impact amplitude. According to DE 4306524, a hand-held electric rotary machine tool has a pressing force sensor which regulates the rotational speed and torque intuitively depending upon pressure by regulating means. The automatic activation which is carried out by a minimum contact pressure after placement can result in unexpected rotation of the hand-held electric machine tool for the user. Further, pressure-dependent regulation is undesirable for many applications in commercial construction, e.g., color mixing, core drilling, and bore hole lengthening.

According to U.S. Pat. No. 5,014,793, a hand-held electric rotary machine tool has a motionless trigger switch at a handle on the workpiece side with a force sensor which activates the automatic speed regulation after an initial actuation by means of the index finger. This automatic speed regulation depends on the force of the index finger on the trigger switch. The force applied by the index finger requires a motor control on the part of the user that is not intuitively correlated with the handling of the hand-held electric machine tool.

### SUMMARY OF THE INVENTION

It is the object of the invention to realize a safe, intuitive control of an at least partly rotary hand-held electric machine tool.

This object is met in accordance with the invention by an at least partly rotary hand-held electric machine tool with a tool receptacle for a tool substantially having a press switch for activating the connection of a power source to an electric motor, which press switch is arranged at a handle on the workpiece side and covers this handle on the workpiece side only partially. The electric motor is connected to control electronics which are connected to a force sensor that is designed and suitably arranged between the tool receptacle and the handle for measuring a pressing force of the hand-held electric machine tool pressing against a workpiece.

The control of the electric motor which is safely intuitively activated by the grip reflex is also intuitively correlated with the handling of the hand-held electric machine tool by the force sensor which is designed to measure the pressing force against a workpiece.

The press switch is advantageously constructed as a discrete switch so that its discrete switching states are usable directly for controlling the control electronics.

The control electronics are advantageously controllably connected to a mode selector switch so that different control programs can be selected with variously selected operating modes of the control electronics.

The hand-held electric machine tool advantageously has a hammer element which is movable in an axially limited manner and which is axially displaceable with respect to the tool receptacle by a maximum of 1 mm, so that axial play in the tool receptacle is reduced by dispensing with an otherwise necessary mechanical switching off of the hammer over a switching path of the hammer element greater than 1 mm which is made possible by the pressing force-dependent control and a more exact starting and working in the drill-chisel and chisel operating modes is made possible.

In a first control process associated with an at least partly rotary operating mode, the control is activated in a first step by actuating the press switch; in a second step, the control controls the electric motor depending upon a force which is measured by the force sensor and which is correlated with the pressing force with which the hand-held electric machine tool is pressed against the workpiece.

The required readiness of the user to safely guide a hand-held electric rotary machine tool is detected by the activation of the control, which activation is separate from the intuitive control of the hand-held electric machine tool through pressing force and is carried out by actuating the press switch.

In a second step, the sensitivity of the control with respect to the force measured by the force sensor is carried out depending upon an activation period of the second step; it is further advantageous that this takes place in a decreasing manner with respect to the activation period, so that the hand-held electric machine tool responds sensitively to the pressing force in a low-power drilling operating mode that is optimal for tap or spot drilling.

In the second step, the control always controls the electric motor above a minimum rotational speed which is optionally dependent upon the operating mode, so that the action of the control can be reliably detected by the user through a movement of the tool.

In a second step, when a negative force is measured by the force sensor, the control advantageously controls the electric motor proportional to the amount of negative force so that the pulling force required to pull the tool out of the workpiece causes a rotary driving to prevent jamming of the tool.

In a third step, the control is advantageously deactivated when the press switch is released so that the control is terminated intuitively when the grip of the user's hand around the handle is loosened.

In a second operating mode selected by the mode selector switch in the second step, the electric motor is advantageously controlled independent from the force measured by the force sensor, which is particularly advantageous for a high-speed operating mode with maximum rotational speed.

In a non-rotary, second operating mode in the first step, the activation of the control is advantageously carried out by a triggering actuation or release of the press switch within a trigger period of a maximum of 0.5 s, so that the activation is carried out by a click and therefore the press switch need no longer be constantly actuated during the second step so that the index finger in particular is relaxed in the chisel operating mode.

In a non-rotary, second operating mode in the third step, the control is advantageously deactivated by a repeated triggering actuation of the press switch alternating with the first step over a time period of a maximum of 0.5 s, so that the chisel operating mode is terminated intuitively by a repeated click.

Alternatively, in a non-rotary, second operating mode, the activation of the control in the first step is advantageously carried out at a measured force peak greater that an activating force, advantageously within a trigger period of less than 0.5 s, so that a kick start is realized in the chisel operating mode.

In a non-rotary, second operating mode in the third step, the control is advantageously deactivated in case the measured force is constantly less than a minimum force over an idling period so that an intuitive switching off is carried out in this operating mode by a time-out which, in particular in a hammering operating mode, interrupts the generation of hammer blows. Accordingly, a hammer switch-off which would otherwise be necessary to prevent idling hammer blows and which was usually realized mechanically by a sufficiently long switching path of the hammer element can be dispensed with.

### BRIEF DESCRIPTION OF THE DRAWINGS

The invention will be described more fully with reference to the drawings wherein:

FIG. 1 is a schematic view of the hand-held electric machine tool according to the invention;

FIG. 2 is a block diagram showing the control according to the invention;

FIG. 3 is a flow chart showing the control process according to the invention; and

FIGS. 4a-4f are graphs showing the control functions according to the invention.

### DETAILED DESCRIPTION OF THE INVENTION

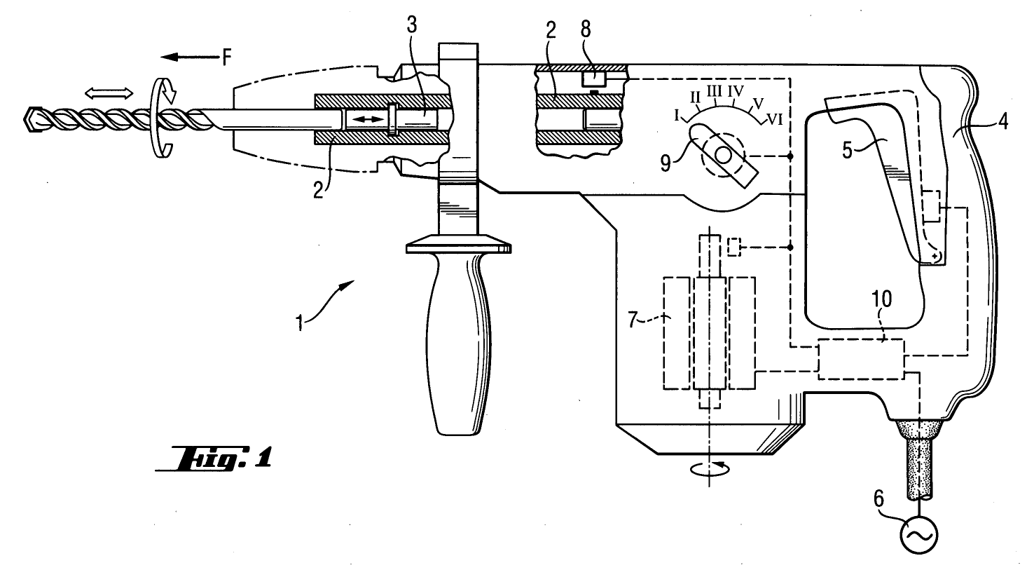

According to FIG. 1, a partly rotary and hammering hand-held electric machine tool 1 with a tool receptacle 2 for a tool has a hammer element 3 which is axially movable to a limited degree and which is displaceable axially by only 0.5 mm with respect to the tool receptacle 2. A press switch 5 in the form of a potentiometer switch for activating the connection of a power source 6 in the form of a power supply network to a driving electric motor 7 is arranged at a handle 4 on the workpiece side and covers this handle 4 only partially. A force sensor 8 which is suitable for measuring a pressing force F with which the hand-held electric machine tool 1 is pressed against a workpiece is arranged between the tool receptacle 2 and the handle 4. The different operating modes I-VI of the hand-held electric machine tool 1, which comprise drill/chisel, low-power drilling, high-speed, chisel, chisel/time-out, chisel/kick start functions, can be selected by a mode selector switch 9 which can be actuated externally and which is connected to control electronics 10 for the electric motor 7.

According to FIG. 2, control electronics 10 (including control 11, regulation 12 and output electronics 13) are arranged in the electric circuit between the power source 6 and the electric motor 7 and are controllably connected to the press switch 5, the force sensor 8 and the mode selector switch 9. The standardized control function OV=f (PM, CF, FS, t) for controlling the regulation of the rotational speed n of the electric motor 7 which is stored in the memory of the control electronics 10 constructed as a microcontroller is a function f of the standardized control parameters PM, CF, FS, t, where

PM is the control parameter of the press switch 5

CF is the pressing force parameter of the force sensor 8

FS is the function parameter of the mode selector switch 9

t is time.

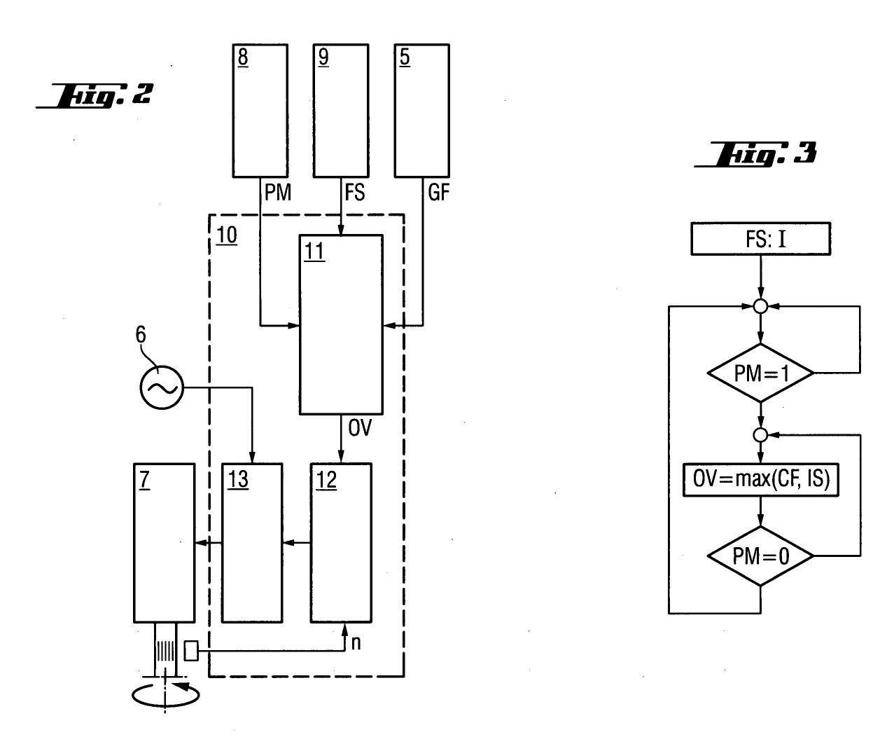

According to FIG. 3, in a first step, the control parameter PM which changes as a result of actuating the discrete press switch is monitored in the drill/chisel rotary and hammering operating mode I with the function parameter FS:I by the control electronics in a three-step control process. When actuated by PM=1, the intuitive control OV=max (CF, IS) is activated. In a following second step, the speed regulation of the electric motor is controlled, with control function CF, proportional to the pressing force parameter CF, but at least proportional to the standardized idling parameter IS. When the press switch is released by PM=0, the intuitive control is terminated in the following third step and is brought back to the starting point of the control process for FS:I.

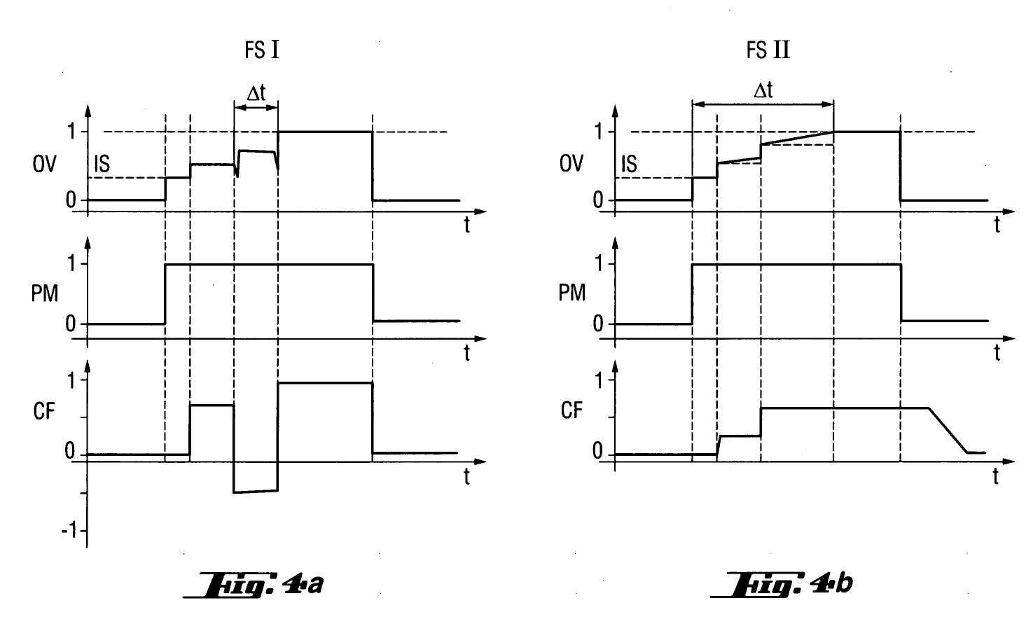

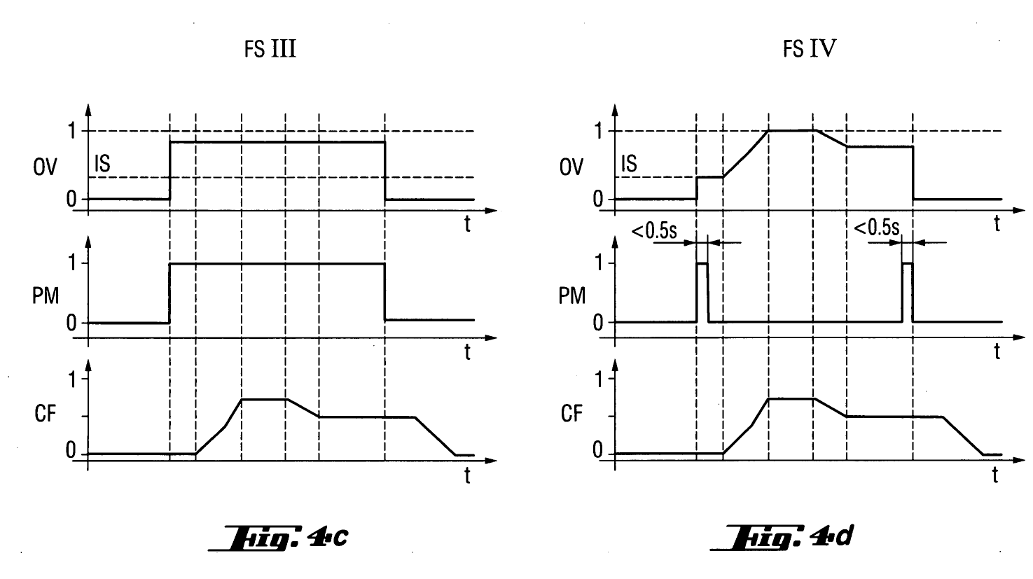

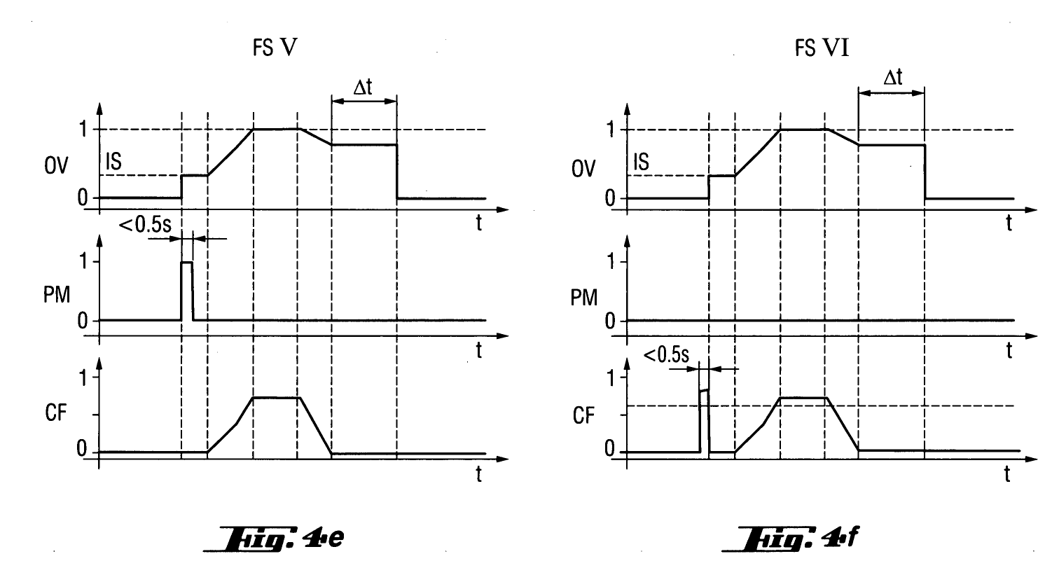

FIGS. 4a to 4f show the control functions OV=f (PM, CF, t) for different function parameters FS of operating modes I-VI.

According to FIG. 4a, the control is activated in the drill/chisel operating mode I as long as the control parameter PM signals an actuation of the press switch. When the intuitive control is activated, the control function OV is carried out independent from time t proportional to the pressing force parameter CF, and an idle parameter IS associated with the minimum speed of 50 rpm in the drill/chisel operating mode I as lower limiting value is maintained. In a time domain Δt of a negative force CF<0 which is measured by the force sensor and lies below a negative threshold value, the electric motor is controlled proportional to the amount of this negative force.

According to FIG. 4b, in the low-power drilling operating mode II, the sensitivity of the control function OV increases progressively with the activation period of the second step through the pressing force parameter CF within a time domain Δt, and a lower limit value associated with the minimum rotational speed of 60 rpm in the low-power drilling operating mode is maintained.

According to FIG. 4c, in the purely rotary high-speed operating mode III in the second step, the control function OV is constantly close to an upper limit value associated with a high rotational speed of 1000 rpm independent from the time t and the pressing force parameter CF.

According to FIG. 4d, the activation or deactivation of the intuitive control is carried out in the purely hammering chisel operating mode IV by control function OV by a triggering actuation of control parameter PM with a click within 0.5 s and the control function OV is then proportional to the pressing force parameter CF, but is at least proportional to the idle parameter IS.

According to FIG. 4e, the activation of the intuitive control is carried out in the purely hammering chisel/time-out operating mode V through the control function OV by a triggering actuation of control parameter PM with a click within 0.5 s, whereas the deactivation is carried out when falling below a lower threshold value associated with the idle stroke by the pressing force parameter CF over a time domain Δt.

According to FIG. 4f, in the purely hammering chisel/kick start operating mode VI, activation is carried out independent from the control parameter PM by temporarily exceeding the pressing force parameter CF of an upper threshold value associated with the activation force peak within 0.5 s. The deactivation is carried out when falling below a lower threshold value associated with the idle stroke by the pressing force parameter CF over a time domain Δt.

What is claimed is:

1. A hand-held electric machine tool with an at least partly rotary-driven tool receptacle (2) for a tool and a press switch (5) arranged at a handle (4) on the workpiece side for activating the connection of a power source (6) to an electric motor (7) connected to control electronics (10) that are connected to a force sensor (8), wherein the force sensor (8) is arranged between the tool receptacle (2) and the handle (4) and measures a pressing force (F) of the hand-held electric machine tool pressing against a workpiece.

2. The hand-held electric machine tool of claim 1, wherein the press switch (5) is a discrete switch.

3. The hand-held electric machine tool of claim 1, wherein the control electronics (1) are controllably connected to a mode selector switch (9).

4. The hand-held electric machine tool of claim 3, wherein a hammer element (3) is provided that is movable in an axially limited manner and that is axially displaceable with respect to the tool receptacle (2) by a maximum of 1 mm.

5. A control process for a hand-held electric machine tool (1) with a first at least partly rotary operating mode (I) for rotating a tool receptacle (2) for a tool, wherein the control is activated in a first step by actuating a press switch (5) arranged on the workpiece side of a handle (4) and, in a second step, the control controls the electric motor (7) depending upon a force measured by the force sensor (8), wherein the force is correlated with the pressing force (F) with which the hand-held electric machine tool (1) is pressed against the workpiece.

6. The control process of claim 5, wherein, in the second step, the sensitivity of the control with respect to the force measured by the force sensor (8) is carried out depending upon an activation period of the second step and increases progressively.

7. The control process of claim 6, wherein the control always controls the electric motor (7) above a minimum rotational speed which is dependent upon the operating mode (I, II) in the second step.

8. The control process of claim 7, wherein, in the second step, when a negative force is measured by the force sensor, the control controls the electric motor independent from the amount of negative force.

9. The control process of claim 8, wherein the control is deactivated in a third step when the press switch (5) is released.

10. The control process of claim 9, wherein the electric motor (7) is controlled independent from the force measured by the force sensor (8) in the second step in a second operating mode (III) selected by the mode selector switch (9).

11. The control process of claim 10, wherein the activation of the control is carried out in a non-rotary, second operating mode (IV, V) in the first step by one of a triggering actuation and a release of the press switch (5) within a trigger period of less than 0.5 s.

12. The control process of claim 11, wherein the control is deactivated by a repeated triggering actuation of the press switch (5) alternating with the first step over a time period of a maximum of 0.5 s.

13. The control process of claim 10, wherein the activation of the control is carried out in a non-rotary, second operating mode (VI) in the first step at a force peak measured by the force sensor (8) at greater that an activation force, within a trigger period of less than 0.5 s.

14. The control process of claim 13, wherein the control is deactivated in the third step in case the measured force is constantly less than a minimum force over an idling period.
